(19) United States
(12) Patent Application Publication
(10) Pub. No.: US 2025/0102006 A1
(43) Pub. Date: Mar. 27, 2025

(54) QUICK-RELEASE COUPLING DEVICE FOR OPTICAL EQUIPMENT AND THE LIKE, IN PARTICULAR FOR CINE-PHOTOGRAPHIC EQUIPMENT

(71) Applicant: VIDENDUM MEDIA SOLUTIONS S.P.A., Cassola (VI) (IT)

(72) Inventors: Simone ECHERLE, Cassola (VI) (IT); Sergi CLAVERAS, Cassola (VI) (IT); Stelvio ZARPELLON, Cassola (VI) (IT); Paolo SPEGGIORIN, Cassola (VI) (IT)

(73) Assignee: VIDENDUM MEDIA SOLUTIONS S.P.A., Cassola (VI) (IT)

(21) Appl. No.: 18/293,565

(22) PCT Filed: Jul. 20, 2022
(86) PCT No.: PCT/IB2022/056681

§ 371 Date: Jan. 30, 2024

(30) Foreign Application Priority Data
Aug. 6, 2021 (IT) 102021000021374

(51) Int. Cl. F16B 21/16; F16M 11/04; G03B 17/56

(52) U.S. Cl. CPC F16B 21/165; F16M 11/041; G03B 17/561

(57) ABSTRACT

A quick-release coupling device for optical equipment includes male and female elements that can be coupled. The male element includes a cylindrical body having a circumferential groove and the female element includes a sleeve body defining an engagement seat that extends along an axial direction and is arranged to house the cylindrical body in a coupled manner.

The device includes retaining members guided radially in respective seats of the sleeve body and selectively project into the engagement seat in order to engage with the circumferential groove and a collar guided axially outside the sleeve body and has, for each, a respective slider inclined with respect to the axial direction to move the corresponding retaining member radially into the seat resulting from movement of the collar along the axial direction. A springing member urges the collar to a position where the sliders move the respective retaining members inside the engagement seat.

### TECHNICAL FIELD

The present invention relates to a quick-release coupling device for optical equipment and the like, in particular for cine-photographic equipment, having the features set out in the preamble to the main claim.

### TECHNOLOGICAL BACKGROUND

“Optical equipment” in this context refers to any equipment that requires being mounted on a support (such as a tripod or stand, a plate for photographic equipment, a support for laser levels and the like) or other member used in the industry.

Normally, the equipment and the supports are equipped with respective coupling means and counter-means, typically of the screw and nut or bayonet type, which allow the equipment to be reversibly attached to the support.

However, such means have the serious drawback of requiring long manoeuvring times for both coupling and uncoupling.

This is in stark contrast to a need particularly felt in the cine-photographic field to very quickly mount equipment on respective supports and transfer it just as quickly from one support to another. The need is particularly acute where photos or films of events that are difficult to repeat are to be taken. Obviously, in said circumstances it is very important not to waste time in assembling or transferring the equipment in order to be able to capture the essential moment.

In this case, quick coupling devices are used which include two mutually engageable elements that are respectively attached to the support and to the equipment with the object of being able to couple or uncouple them in a very short time.

An example of said devices is described in US2020/0272031. The system adopted in this case makes use of a male and a female element that may be coupled together by retaining members on the female element to hold the male and female elements in reciprocal coupling when engaged with one another. The coupling takes place by snapping and is almost instantaneous, due to the insertion of the male element into a seat on the female element, which causes the retaining members to be released. However, this solution has the disadvantage in that it requires the unequivocal alignment of certain parts which act as a reference for the correct insertion condition and allow the retaining members to be snapped together when the respective positional references are in precise alignment.

This implies that in addition to inserting the male element into the female element, it is necessary to rotate these elements relative to each other to find the correct angular coupling position. Otherwise, the coupling between the two engagement elements does not take place. It is clear that this necessity may seriously jeopardise the possibility of rapidly preparing the equipment.

### DESCRIPTION OF THE INVENTION

The technical problem underlying the present invention is that of providing a quick-release coupling device for optical equipment and the like, in particular for cine-photographic equipment, which is structurally and functionally designed to overcome at least some of the drawbacks mentioned with reference to the cited prior art.

In particular, it is an object of the present invention to obtain a quick-coupling device that may be effectively used in any corresponding engagement position of a male and a female element without requiring the alignment of references or the like.

Another object of the invention is to ensure maximum coupling rigidity in all of the most varied working conditions, such as in cases in which the centre of gravity of the equipment is not precisely above the vertical passing through the coupling device, when imbalances are therefore created that also place bending stresses on the device which must be adequately withstood by the device without creating play that is perceptible to the user.

This problem is solved and these and other objects are achieved by the invention by means of a coupling device obtained according to one or more of the attached claims.

In a first aspect thereof, the present invention is thus aimed at a quick-release coupling device for optical equipment and the like, in particular for cine-photographic equipment, comprising a male and a female element which can be coupled in engagement with each other.

The male element preferably comprises a cylindrical body on which a circumferential groove is made.

The female element preferably comprises a sleeve body defining an engagement seat designed to house the cylindrical body in coupling.

Preferably the engagement seat is extended along an axial direction of the sleeve body.

Preferably, the device comprises a plurality of retaining members housed in respective seats of the sleeve body and guided to slide within them.

Preferably, the retaining members are guided within their respective seats along a radial direction which is defined on the sleeve body.

Preferably, the retaining members selectively project into the engagement seat in order to engage the circumferential groove so as to hold the male and female elements in mutual coupling when engaged with each other.

Preferably, the device comprises a collar guided axially outside the sleeve body.

Preferably, the collar has, for each retaining member, a respective slider which is inclined with respect to the axial direction, so as to move the corresponding retaining member radially in the engagement seat as a result of a movement of the collar and/or of the corresponding slider along the axial direction.

The collar is preferably mounted in springy way on the sleeve body; more preferably the device comprises at least one springing member that resiliently urges said collar towards a position such that said sliders move the respective retaining members within the seat.

In a preferred embodiment, a ring nut is mounted on the collar, said ring nut being preferably rotatable about the axial direction.

Moreover, cam means are preferably arranged between the ring nut and the collar to rotate the ring nut about the axial direction as a result of the axial movement of the collar and vice versa.

In this way, the male element may be automatically engaged and retained in the seat of the female element in any relative angular position about the coincident axis of the seat and the cylindrical body without any need for matching predetermined angular insertion positions.

In a preferred embodiment, the cam means comprise several pins fixed to one of the ring nut and the collar engaged in sliding within respective grooves obtained on the other of the ring nut and the collar.

Preferably, the respective grooves have a variable inclination with respect to the axial direction.

In this way, it is possible to calibrate the efficiency and speed of relative movements between the collar and ring nut according to the different operating phases: when opening, in fact, it is preferable to have greater speed of axial movement of the collar (thus a groove segment that is relatively little inclined with respect to the axial direction in order to have a lot of axial movement with little rotation of the ring nut), whereas when closing, it is preferable to have greater force on the rollers to ensure maximum clamping (thus a groove segment that is relatively very inclined with respect to the axial direction in order to have small axial movements of the collar with significant rotation of the ring nut), which would not otherwise be ensured by the springing member alone.

In alternative embodiments, the collar may be moved along the axial direction using different systems.

In a preferred embodiment, the device further comprises a flange housed in the sleeve body. Preferably, this flange slides axially within the engagement seat between a first position, in which it closes, at least partially, the seats of the retaining members by preventing them from protruding into the engagement seat, and a second position, in which it frees said seats by releasing the retaining members.

In other words, in the first position, the flange holds the retaining members within their respective seats, while in the second position, the flange does not interfere with the radial movement of the retaining members, which may possibly be pushed by their respective sliders within the engagement seat.

Preferably, the flange is resiliently urged in the first position by an appropriate spring and is moved to the second position when pressed axially by the cylindrical body as a result of its insertion into said engagement seat.

This allows for the retaining members to be held back so that they do not project into the seat when the male and female elements are decoupled and for said elements to be automatically and instantly released as a result of the insertion of the male element into the seat of the female element when they are coupled together. In this case, the coupling is obtained by a snap-coupling, which is very fast and produces optimal clamping.

Preferably, on the cylindrical body axially opposed first and second ends are defined.

Preferably, this cylindrical body comprises, at the first end, a support plate for optical equipment and in particular for cine-photographic equipment.

Preferably, at the first end there is at least one attachment element for optical equipment and in particular for cine-photographic equipment, such as a standard screw mount. More preferably, said attachment element is mounted on said support plate.

Preferably, the support plate has a larger diameter than the engagement seat.

Preferably, the support plate has a perimeter edge with a conical profile, tapering towards the second end of the cylindrical body.

Preferably, the sleeve body has a mouth on the engagement seat having a larger diameter than the engagement seat and a perimeter edge with a tapered profile towards the engagement seat to house the support plate in engagement.

In this way, when the cylindrical body is inserted into the engagement seat, the support plate is housed in the mouth, and the alignment between the respective perimeter edges of the support plate and the mouth ensures an effective and firm hold between the two elements, particularly in bending.

Preferably, the second end has an annular shape and, more preferably, has a tapered section, e.g., trapezoidal, which engages a corresponding annular indentation on the upper surface of the flange.

Preferably, the circumferential groove is obtained near the second end.

In this way, the groove may be engaged very quickly by the retaining members. Moreover, the male element is aligned and held in the female element at two points (circumferential groove and perimeter edge of the support plate) as far apart as possible, in order to increase the resistance to bending.

Preferably, the circumferential groove and the retaining members are shaped such that the radial thrust of the retaining members against the circumferential groove determines a thrust of the cylindrical body towards the inside of the engagement seat.

In this way, the retaining members forcefully hold the cylindrical body within the engagement seat and also increase the engagement between the support plate and the mouth.

Preferably, the circumferential groove has a V-shaped cross section.

Preferably, the retaining members are more than two and preferably they are three, arranged equiangularly at 120° to each other.

Preferably, the retaining members comprise a roller with an axis perpendicular to this axial direction.

Preferably, each roller is housed at the opposing axial ends in respective seats obtained in the sleeve body to be guided between the first and second position.

Preferably, a respective groove is obtained between the respective receiving seats of the axial ends of each roller, within which the respective slider of the collar is housed and guided.

### BRIEF DESCRIPTION OF THE DRAWINGS

The features and the advantages of the invention will become apparent from the detailed description of a preferred embodiment thereof, illustrated, by way of non-limiting example, with reference to the appended drawings, wherein:

FIG. 1 is a schematic perspective view of a quick-coupling device obtained according to the present invention in a coupled condition of the male and female elements,

FIG. 2 is a schematic perspective view similar to FIG. 1 in the decoupled condition of the male and female elements,

FIGS. 3 and 4 are views of the device in FIG. 1 with some components removed,

FIG. 5 is an axial cross-sectional view of the device in FIG. 1 in decoupled condition,

FIG. 6 is a side elevation view of the device in FIG. 5 with an external component in transparency,

FIG. 7 is an axial cross-sectional view of the device in FIG. 1 in coupled condition,

FIG. 8 is a side elevation view of the device in FIG. 7 with an external component in transparency.

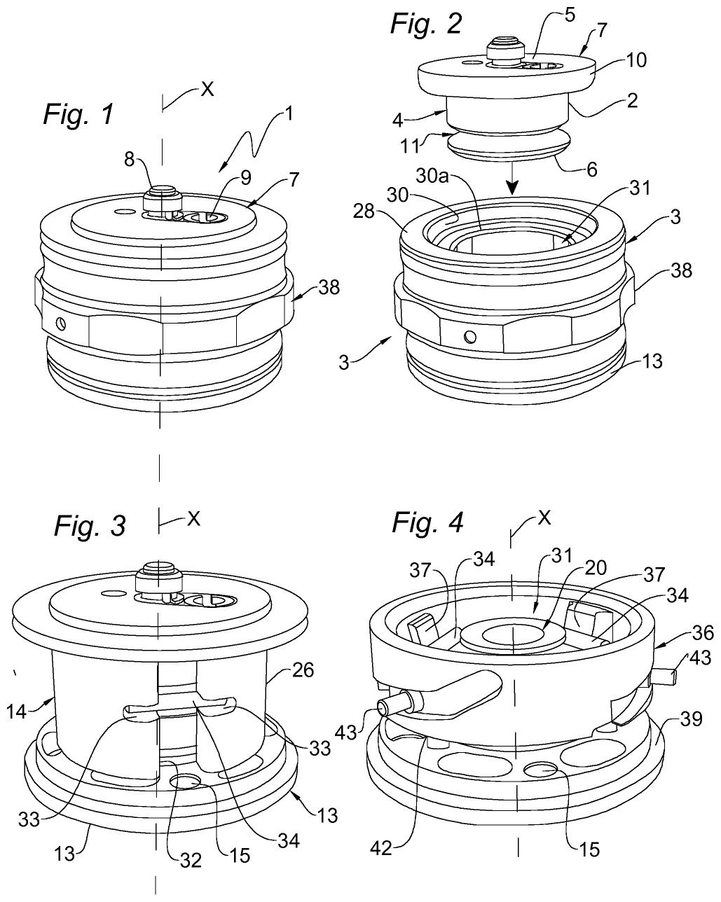

### PREFERRED MANNER OF OBTAINING THE INVENTION

In the illustrations, a quick-release coupling device for optical equipment and the like, in particular for cine-photographic equipment, is collectively referred to as 1. The device is suitable, for example, for mounting on a support such as a tripod, stand, etc., any equipment that requires a stable, quick, and easily releasable anchorage to the support. Typically said equipment may comprise photo-cinematographic equipment and devices, laser devices, lighting systems, reflectors, etc.

The device 1 comprises a male element 2 and a female element 3 that may be coupled to each other. For this purpose, the male element 2 preferably comprises a cylindrical body 4 having axially opposed first and second ends 5, 6.

In the example embodiment illustrated herein, the cylindrical body 4 bears at its first end 5 a support plate 7 provided with attachment members 8 and 9 by means of which the male element 2 is fixed in corresponding receiving members of the equipment (not shown herein as it is unrelated to the present invention).

The perimeter edge 10 of the support plate 7 is preferably tapered towards the second end 6 with an essentially conical profile. This profile favours the centring of the male element 2 in the female element 3 and also increases the stability of their coupling, as will be explained below. In the vicinity of the second end 6, a circumferential groove 11 is formed in the outer wall of the cylindrical body 4, preferably with a V-shaped cross section.

The female element 3 comprises a flanged base 13 to which a sleeve body 14 is attached. Preferably the base 13 and the sleeve body 14 have a circular profile and are mounted coaxial to an axial direction X. In the base 13, blind holes 15 are obtained, which are circumferentially spaced apart in pitch and constitute seats for the same number of compression springs 16. It is obvious that the springs may be mounted on the base 13 in another way, e.g., fitted on appendages or otherwise guided, as well as the fact that the plurality of springs may be replaced with a single spring system as will become clearer hereinafter.

Centrally, the base 13 has an internally threaded tube 17 to house a threaded attachment for a support such as a tripod or stand (not shown). A mushroom-shaped appendage 20 is screwed to the end of the tube 17, said appendage serving as a retaining member for a flange 19 sliding outside the tube 17 and resiliently urged towards the mushroom-shaped appendage 20 by a spring 18.

The sliding flange 19 is provided perimetrically with a cylindrical shell 21 and has axially opposed faces respectively provided with a circumferential indentation 22 and a support surface 23 for the spring 18, which is located on the opposite side on the base 13.

The sleeve body 14 preferably consists of three or more sectors all indicated with 26 which are fixed to the base 13 by means of screws 27 or the like and are joined together on opposite sides by a circumferential flange 28. In the part between the flange 28 and the base 13 and delimited laterally by the sectors 26, the sleeve body 14 defines a cylindrical engagement seat 31, extended axially along the axial direction X, adapted to house the insertion of the cylindrical body 4 of the male element 2.

The circumferential flange 28 forms a mouth on the engagement seat 31 and comprises a perimeter edge 30 and a shoulder 30a that connects to the sectors 26. The perimeter edge 30 of the flange 28 has a conical profile corresponding to the conical profile of the perimeter edge 10 of the support plate 7, such that it houses with friction the perimeter edge 10 of the support plate 7 of the male element 2 when said element is inserted into the engagement seat 31. This ensures that the male and female elements are not only axially clamped when engaged in each other, but also substantially integral in rotation, i.e., a relative rotation of the male element with respect to the seat in which it is engaged is strongly restrained.

The sectors 26 are spaced circumferentially so that a groove 32 is defined between contiguous sectors. Adjacent sectors 26 have, in corresponding positions, respective radial guides 33 adapted to axially restrain, but with the ability to radially move, a respective roller 34. The radial guides 33 form seats that house and guide the rollers 34 at the respective axial ends of the rollers 34.

The rollers 34 may be replaced with balls, teeth, or equivalent bodies having the capacity for radial movement between a first position, in which they project into the engagement seat 31, and a second position, in which they are retracted away from the engagement seat. When the male element 2 is inserted into the engagement seat 31 of the female element, the rollers 34 are urged to project into the seat 31, engaging the groove 11 so as to axially hold the male and female elements in mutual engagement. Said rollers 34 therefore constitute retaining members between the male and female elements of the coupling device 1.

A collar 36 is axially guided outside the sleeve body 14 and has for each groove 32 and corresponding roller 34 a respective slider 37 inclined with respect to the axial direction X to taper towards the base 13 so as to move the corresponding roller 34 radially into the engagement seat 31 as a result of an axial movement of the collar 36.

The collar 36 is spring-mounted on the sleeve body by means of springing members constituted of the springs 16 resiliently urging said collar away from the base 13 and in particular towards a position such that the sliders 37 move the respective rollers 34 within the engagement seat 31 to engage the groove 11. It will be observed that as a result of the interaction of the sliders 37 in the grooves 32, which form a corresponding coupling of the grooved profile type, the collar 36 slides axially with respect to the sleeve body but is rotationally integral therewith.

A ring nut 38 is preferably mounted to rotate with respect to the collar supported by respective annular shoulders 39, 40 of the base 13 and circumferential flange 28, respectively. Cam means are provided between the ring nut 38 and the collar 36 to rotate the ring nut 38 about the axial direction X as a result of the axial movement of the collar 36 and vice versa.

In an improved aspect of the present invention, there is provided a cam profile system between the ring nut 38 and the collar 36, which preferably includes three circumferentially equally spaced grooves 42 on the outer wall of the collar 36 and three corresponding cam-follower pins 43, similarly equally spaced on the inner wall of the ring nut 38 and engaged in the grooves 42 of the collar 36 so that, due to the effect of the rotation of the ring nut, an axial movement of the collar is obtained, and vice versa, due to the effect of the movement of the collar, a corresponding rotation of the ring nut is obtained. This effect arises from the fact that the grooves defining the cam profiles are not oriented circumferentially, but rather inclined according to an overall helical pattern, so that the rotation of the ring nut that presides over the clamping of the male and female elements is automatically obtained due to the translation of the collar on the sleeve body.

Preferably, the grooves 42 have a variable inclination with respect to the axial direction X, so that there is a segment at a greater inclination with respect to the axial direction X when the collar 36 is raised in the thrust position of the rollers 34 toward the inside of the engagement seat 31 and a segment at a lesser inclination with respect to the axial direction X when the collar 36 is lowered to allow the rollers to return radially within their respective seats 33.

The operation of the device of this invention is as follows.

First the male element 2 is applied to the desired fixture and the female element 3 to the respective support as shown above. Several identical male elements may be applied to different pieces of equipment to make them interchangeable on the support.

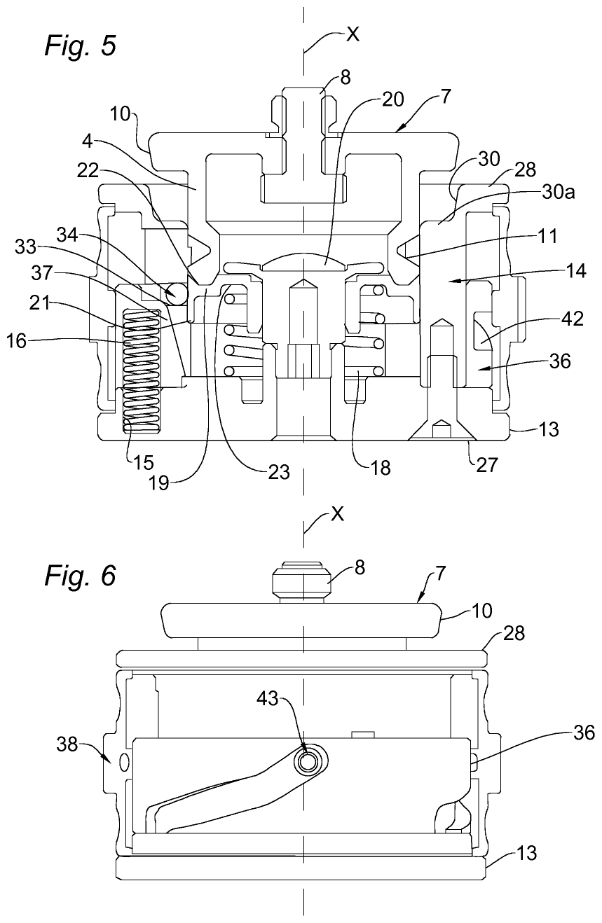

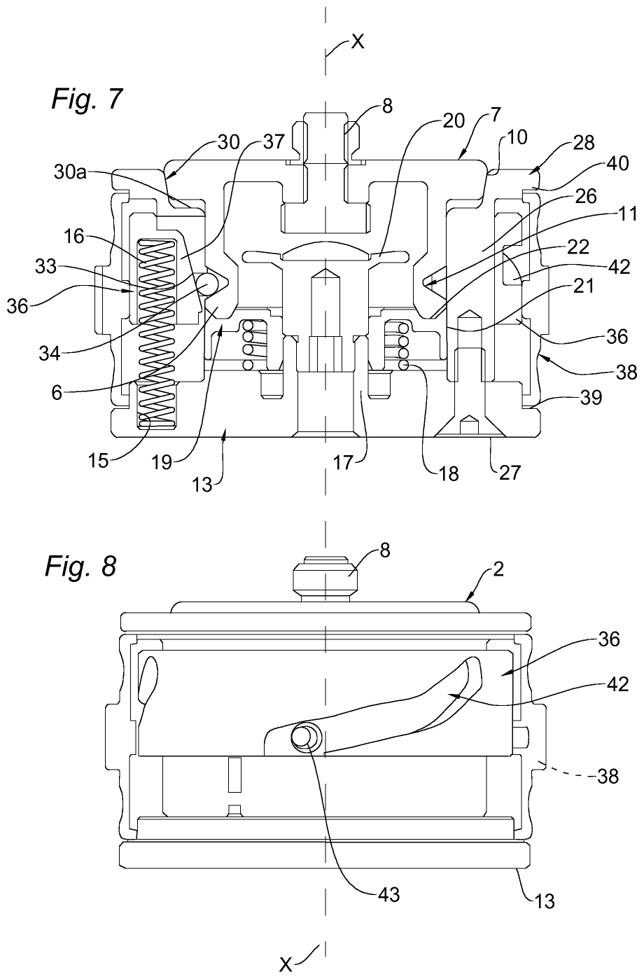

Then the desired equipment with its male element 2 is fitted onto the engagement seat 31. In this condition, the female element 3 appears with the arrangement of parts depicted in FIGS. 5 and 6.

In particular, it shall be observed that as a result of the manual rotation of the ring nut 38, the collar 36 is located close to the base 13, the springs 16 are compressed, and the cam-follower pins 43 are located at the highest part of the respective grooves 42, in the segment with the smallest inclination with respect to the axial direction X.

In this condition, the sliders 37 press the rollers 34 into their respective radial seats 33, but these are held by the protrusion into the seat 31 of the cylindrical shell 21 of the slidable flange 19, which, urged by the spring 18, is held against the mushroom-shaped appendage 20.

By exerting further pressure to insert the male element into the engagement seat 31, the second end 6 of the male element presses against the spring flange 19, moving it towards the base 13. In this way, the second end 6 of the male element replaces the shell 21 of the flange 19 in the function of holding the rollers 34 in 1o their respective radial guides 33. When the male element approaches the base 13 such that the circumferential groove 11 is positioned at the rollers 34, said rollers are in the condition to snap-engage the circumferential groove due to the thrust exerted by the respective sliders 37 in turn generated by the thrust of the springs 16. The collar 36 is consequently moved over the sleeve body 14 in the direction of the circumferential flange 28.

This results in a rotation of the ring nut 38 due to the engagement of the cam-follower pins 43 in their respective grooves 42. The fixture is thus clamped on the support due to the coupling between the male and female elements held together by the rollers 34.

It should be noted that the thrust of the rollers 34 is preferably exerted on the wall of the circumferential groove 11 facing the support plate 7, so that the radial thrust of the rollers 34 determines an axial thrust of the cylindrical body 4 facing the inside of the engagement seat 31, thereby increasing both the retaining action of the male element 2 in the female element 3 and the meeting and engaging action of the support plate 7 in the flange 28.

This, combined with the provision of three rollers 34 placed 120° apart, makes the coupling between male and female elements particularly stable and effective, minimising the possibility of bending and oscillation.

If necessary, a manual rotation of the ring nut 38 which further raises the collar 36 will further improve this clamping.

Due to this structural configuration, the male element may be automatically engaged and held in the insertion seat of the female element in any relative angular position about the coincident axis of the seat and the cylindrical body, without any need for matching predetermined angular insertion positions.

Moreover, due to the provision of the sliding flange 19 that keeps the rollers 34 inside their respective seats 33, in the absence of the male element 2, the engagement seat is always open, i.e. in a condition to house the male element without the operator having to perform any prior manoeuvre.

This advantageously allows for quick-coupling of the cine-photographic equipment, which may also be heavy and bulky, without the operator having to take his hands off the equipment.

It goes without saying that, in order to meet specific and contingent application requirements, a person skilled in the art may make further modifications and variations to the above-described invention that are nevertheless within the scope of protection as defined by the following claims.

1. Quick-release coupling device for optical equipment comprising:
a male element (2) and a female element (3) which can be coupled in engagement with one another, said male element including a cylindrical body which has a circumferential groove (11) and said female element comprising a sleeve body which defines an engagement seat (31) that extends along an axial direction (X) of the sleeve body (14) and is provided to house said cylindrical body (4) in a coupled manner,
a plurality of retaining members (34) which are guided radially in respective seats (33) of the sleeve body (14) and selectively project into said engagement seat (31) in order to engage said circumferential groove (11) so as to hold said male (2) and female (3) elements in a mutually coupled manner when engaged one inside the other,
a collar (36) which is guided axially on the outside of the sleeve body (14) and has, for each retaining member (34), a respective slider (37) which is inclined with respect to said axial direction (X), so as to move the corresponding retaining member (34) radially in the engagement seat (31) as a result of a movement of the collar (36) and/or of the corresponding slider (37) along said axial direction, and
at least one springing member (16) which resiliently urges said collar (36) towards a position such that said sliders (37) move the respective retaining members (34) inside said engagement seat (31).

2. The device according to claim 1, wherein a ring nut (38) which can rotate about said axial direction (X) is mounted on said collar (36), and cam means are arranged between said ring nut (38) and said collar (36) for rotating said ring nut about said axial direction (X) as a result of the axial movement of the collar and vice versa.

3. The device according to claim 2, wherein said cam means comprise at least one pin (43) fixed to one of the ring nut and the collar, said at least one pin being slidingly engaged inside respective grooves (42) made on the other of the ring nut and the collar, and wherein said respective grooves (42) have a variable inclination with respect to the axial direction.

4. The device according to claim 1, wherein a flange (19) is housed in said engagement seat (31), said flange is slidable along said axial direction between a first position in which said flange closes the seats (33) of the retaining members, thereby preventing the retaining members from projecting into the engagement seat (31), and a second position in which said flange opens said seats (33), thereby releasing the retaining members.

5. The device according to claim 4, wherein said flange (19) is resiliently urged into said first position and is moved into said second position when axially pushed by said cylindrical body (4) as a result of said flange being inserted into said engagement seat (31).

6. The device according to claim 1, wherein a first end and a second end (5, 6) that are axially opposed are defined on the cylindrical body (4), a support plate (7) for said optical equipment being provided at said first end (5), said support plate has a perimeter edge (10) with a conical profile tapered towards said second end (6), and said circumferential groove (11) being formed proximate to said second end (6).

7. The device according to claim 1, wherein said circumferential groove (11) and said retaining members (34) are shaped such that the radial thrust of the retaining members against the circumferential groove (11) determines a thrust of the cylindrical body (4) towards an interior of the engagement seat (31).

8. The device according to claim 1, wherein said retaining members comprise three rollers (34) arranged equiangularly at 120° to one another.

9. The device according to claim 8, wherein each of said rollers (34) is housed at opposing axial ends in respective seats (33) made in said sleeve body (14), between said seats a groove (32) is made, within said groove the relevant slider (37) of the collar (36) is housed and guided.
